(19) United States
(12) Patent Application Publication
(10) Pub. No.: US 2025/0252342 A1
(43) Pub. Date: Aug. 7, 2025

(54) SYSTEMS AND METHODS FOR SELECTING VEHICLES FOR DECENTRALIZED MACHINE LEARNING

(71) Applicant: Toyota Motor Engineering & Manufacturing North America, Inc., Plano, TX (US)

(72) Inventors: Chianing Wang, Mountain View, CA (US); Haoxiang Yu, Austin, TX (US); Alexander T. Pham, San Jose, CA (US)

(73) Assignees: Toyota Motor Engineering & Manufacturing North America, Inc., Plano, TX (US); Toyota Jidosha Kabushiki Kaisha, Toyota-shi, Aichi-ken (JP)

(21) Appl. No.: 18/433,977

(22) Filed: Feb. 6, 2024

(51) Int. Cl. G06N 20/00

(52) U.S. Cl. CPC G06N 20/00

(57) ABSTRACT

A method for updating a machine learning model for vehicles is provided. The method includes obtaining an edge encounter score for each of a pair of vehicles calculated based on a movement momentum of each of the pair of vehicles and a direction from a location of each of the pair of vehicles to each of one or more edge servers, selecting one of the pair of vehicles having a higher edge encounter score than other vehicle, aggregating a machine learning model of the selected vehicle and a machine learning model of the other vehicle of the pair of vehicles, uploading the aggregated machine learning model to one of the one or more edge servers, and operating the selected vehicle based on the aggregated machine learning model.

### TECHNICAL FIELD

The present disclosure relates to systems and methods for distributed machine learning among connected vehicles, more specifically, to systems and methods for selecting a vehicle between a pair of vehicles for decentralized machine learning.

### BACKGROUND

Traditional machine learning is centralized and needs lots of infrastructure resource to support training. Distributed learning methods include decentralized learning and federated learning. The federated learning is a method where clients, e.g., vehicles train a model locally and upload the model to a central server, and the central sever aggregates the trained models from edge devices and sends the aggregated model back to the clients. On the other hand, decentralized learning involves distributing the training process across multiple clients such as vehicles or edge devices such as road-side devices that are connected in a peer-to-peer network. Each client processes a portion of the data and communicates with other clients to share information.

Federated learning requires lots of communication among vehicles, edge servers, and a central server for updating a machine learning model. Whereas decentralized learning does not rely on a central server. Decentralized learning requires that each vehicle identify the locations of other vehicles, edge servers, and other components. However, for conventional decentralized learning, it is unclear which vehicle should collect and aggregate models from a plurality of vehicles.

Accordingly, a need exists for systems and methods for selecting a vehicle between a pair of vehicles that collects and aggregates models from the pair of vehicles.

### SUMMARY

The present disclosure provides systems and methods for selecting a vehicle or a representer between a pair of vehicles that collects and aggregates models from the pair of vehicles.

In one embodiment, a method for updating a machine learning model for vehicles is provided. The method includes obtaining an edge encounter score for each of a pair of vehicles calculated based on a movement momentum of each of the pair of vehicles and a direction from a location of each of the pair of vehicles to each of one or more edge servers, selecting one of the pair of vehicles having a higher edge encounter score than other vehicle, aggregating a machine learning model of the selected vehicle and a machine learning model of the other vehicle of the pair of vehicles, uploading the aggregated machine learning model to one of the one or more edge servers, and operating the selected vehicle based on the aggregated machine learning model.

In another embodiment, a system for updating a machine learning model for vehicles is provided. The system includes a first vehicle comprising a first machine learning model and a processor, and a second vehicle comprising a second machine learning model. The processor is programmed to: obtain an edge encounter score for each of the first and second vehicles calculated based on a movement momentum of each of the first and second vehicles and a direction from a location of each of the first and second vehicles to each of one or more edge servers; determine that the first vehicle has a higher edge encounter score than the second vehicle; aggregate the first machine learning model and the second machine learning model; upload the aggregated machine learning model to one of the one or more edge servers; and operate the first vehicle based on the aggregated machine learning model.

In another embodiment, provided is a non-transitory computer readable medium storing instructions, when executed by a processor, causing the processor to: obtain an edge encounter score for each of a pair of vehicles calculated based on a movement momentum of each of the pair of vehicles and a direction from a location of each of the pair of vehicles to each of one or more edge servers; select one of the pair of vehicles having a higher edge encounter score than other vehicle; aggregate a machine learning model of the selected vehicle and a machine learning model of the other vehicle of the pair of vehicles; upload the aggregated machine learning model to one of the one or more edge servers; and operate the selected vehicle based on the aggregated machine learning model.

These and additional features provided by the embodiments of the present disclosure will be more fully understood in view of the following detailed description, in conjunction with the drawings.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIGS. 1A and 1B schematically depict federated learning through a decentralized learning approach among a plurality of vehicles present in an area, in accordance with one or more embodiments shown and described herewith;

FIG. 1C depicts comparison of the present system with conventional systems;

FIG. 2 depicts a schematic diagram of a system for selecting a vehicle between a pair of vehicles for decentralized machine learning, according to one or more embodiments shown and described herein;

FIG. 3 depicts a flowchart for selecting a vehicle between a pair of vehicles for decentralized machine learning, according to one or more embodiments shown and described herein;

FIG. 4 illustrates an exemplary scenario where a vehicle calculates an edge encounter score, according to one or more embodiments shown and described herein;

FIG. 5 illustrates another exemplary scenario where a vehicle calculates an edge encounter score, according to another embodiments shown and described herein; and

FIG. 6 depicts simulation result of message receptions rates, according to one or more embodiments shown and described herein.

### DETAILED DESCRIPTION

The embodiments disclosed herein include systems and methods for selecting a vehicle between a pair of vehicles that collects and aggregates models from the pair of vehicles. According to the embodiments, a method includes obtaining an edge encounter score for each of a pair of vehicles calculated based on a movement momentum of each of the pair of vehicles and a direction from a location of each of the pair of vehicles to each of one or more edge servers, selecting one of the pair of vehicles having a higher edge encounter score than other vehicle, aggregating, by the selected vehicle, a machine learning model of the selected vehicle and a machine learning model of the other vehicle of the pair of vehicles, uploading, by the selected vehicle, the aggregated machine learning model to one of the one or more edge servers, and operating the selected vehicle based on the aggregated machine learning model.

The present disclosure accurately calculates the chance for a vehicle to encounter edge server by calculating an edge encounter score. Further, the present disclosure uses a decentralized learning method to enhance federated learning. Because the vehicle having a higher edge encounter score operates as a representer, aggregates machine learning models, and transmits the aggregated machine learning model to an edge server, this approach substantially increases the coverage area, reduces communication and computational requirements for edge servers, and decreases the infrastructural cost of the edge servers.

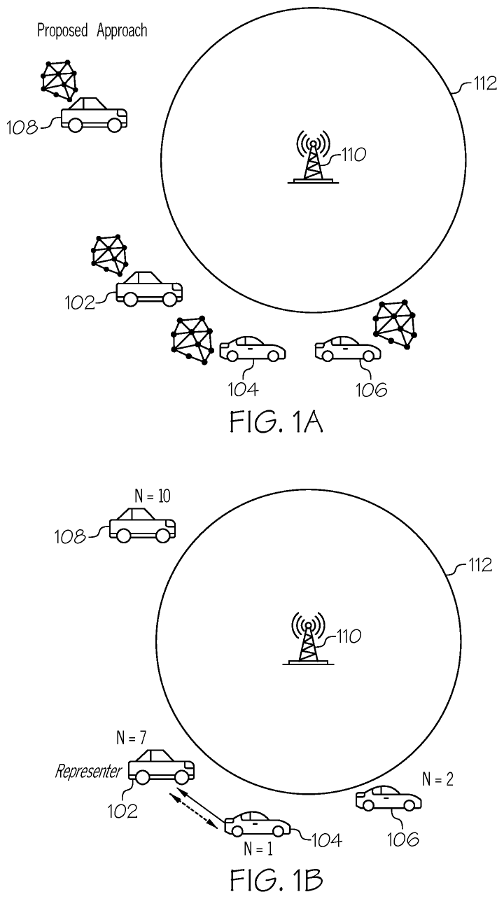

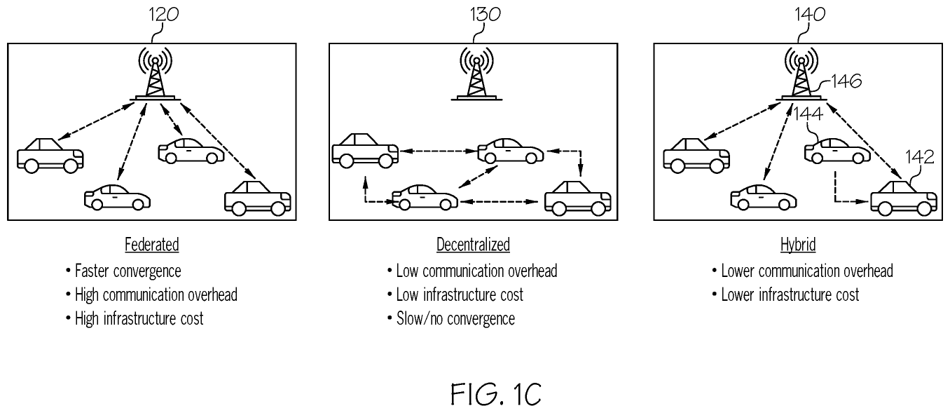

FIGS. 1A and 1B schematically depict federated learning through a decentralized learning approach among a plurality of vehicles present in an area, in accordance with one or more embodiments shown and described herewith.

FIG. 1A depicts a plurality of vehicles 102, 104, 106, 108 near an area 112 covered by an edge server 110. In embodiments, each of the plurality of vehicles 102, 104, 106, 108 may be an automobile or any other passenger or non-passenger vehicle such as, for example, a terrestrial, aquatic, and/or airborne vehicle. Each of the plurality of vehicles 102, 104, 106, 108 may be an autonomous vehicle that navigates its environment with limited human input or without human input. Each of the plurality of vehicles 102, 104, 106, 108 may include actuators for driving the vehicle, such as a motor, an engine, or any other powertrain.

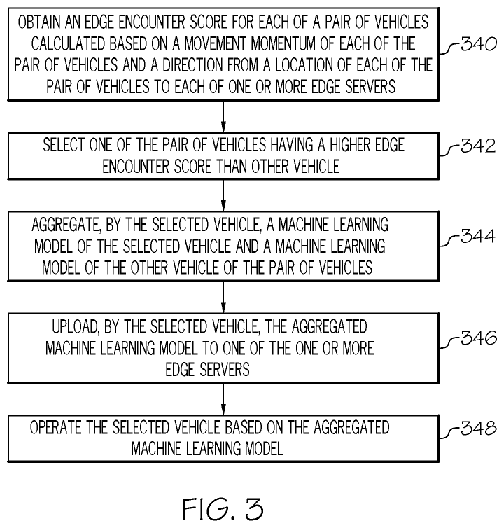

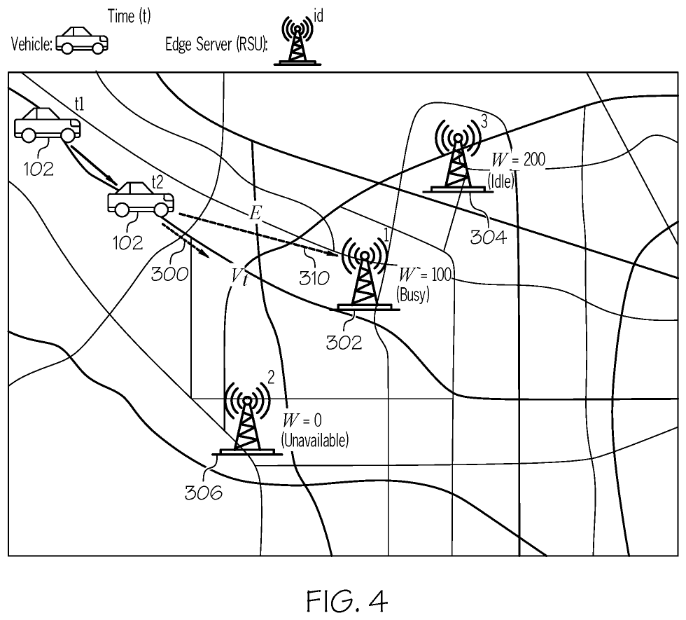

One or more of the plurality of vehicles 102, 104, 106, 108 are moving toward the area 112 and planning to upload their machine learning models to the edge server 110. For example, the vehicle 102 and the vehicle 104 are moving toward the area 112. When the vehicle 102 and the vehicle 104 are close to each other, for example, within a predetermined distance or a communication range, each of the vehicle 102 and the vehicle 104 may calculate its edge encounter score and share the score each other. The details of calculating the edge encounter score will be described below with reference to FIGS. 3 and 4. In embodiments, the vehicle having a higher edge encounter score is selected as a representer who collects and aggregates the machine learning models from vehicles. By referring to FIG. 1B, the vehicle 102 has the edge encounter score of 7 and the vehicle 104 has the edge encounter score of 1. Thus, the vehicle 102 is selected as the representer, and collects and aggregates the machine learning models from the vehicle 102 and the vehicle 104. When the vehicle 102 is within a communication range of the edge server 110, the vehicle 102 delivers the aggregated machine learning model to the edge server 110. The edge server 110 collects aggregated machine learning models from the vehicle 102 and other representers and generate a global machine learning model based on the aggregated machine learning models. Then, the edge server 110 may transmit the global machine learning model to the vehicle 102. The vehicle 102 may perform tasks using the global machine learning model. For example, the vehicle 102 may autonomously drive using the global machine learning model. With this methodology, the edge server 110 does not need to communicate with the vehicle 104, but needs to communicate with the vehicle 102 only with respect to the machine learning models of the vehicles 102 and 104.

Other vehicles such as the vehicles 106 and 108 may also calculate their edge encounter score. For example, the vehicle 106 has the edge encounter score of 2 and the vehicle 108 has the edge encounter score of 10. Whenever each of the vehicle 106 and the vehicle 108 encounters with another vehicle, they compare its edge encounter score with the edge encounter score of the another vehicle and decides who will be the representer. For example, when the vehicle 102 encounters with the vehicle 108, the vehicle 108 becomes the representer between the vehicles 102 and 108 because the vehicle 108 has a higher edge encounter score. As another example, when the vehicle 102 encounters with the vehicle 106, the vehicle 102 becomes the representer between the vehicles 102 and 106 because the vehicle 102 has a higher edge encounter score.

FIG. 1C depicts comparison of the present system with conventional systems. The system 120 depicts a conventional federated learning system. The conventional federated learning system 120 has the advantage of faster convergence of machine learning models, but requires high communication overhead and a higher infrastructure cost. The system 130 depicts a conventional decentralized learning system. The conventional decentralized learning system 130 requires low communication overhead and low infrastructure cost, but has slow or no convergence of machine learning models. In contrast with the conventional leaning systems, the present system 140 combines the advantages of both federated learning and decentralized learning. In the present system 140, the vehicle 142 serves as the representer between the vehicle 142 and the vehicle 144. Even though the vehicle 144 does not communicate directly with the edge server 146, the edge server 146 can still obtain information on the machine learning model of the vehicle 144 from the vehicle 144 via the vehicle 142. The approach of the present system 140 is regarded as the most flexible and feasible for practical implementation.

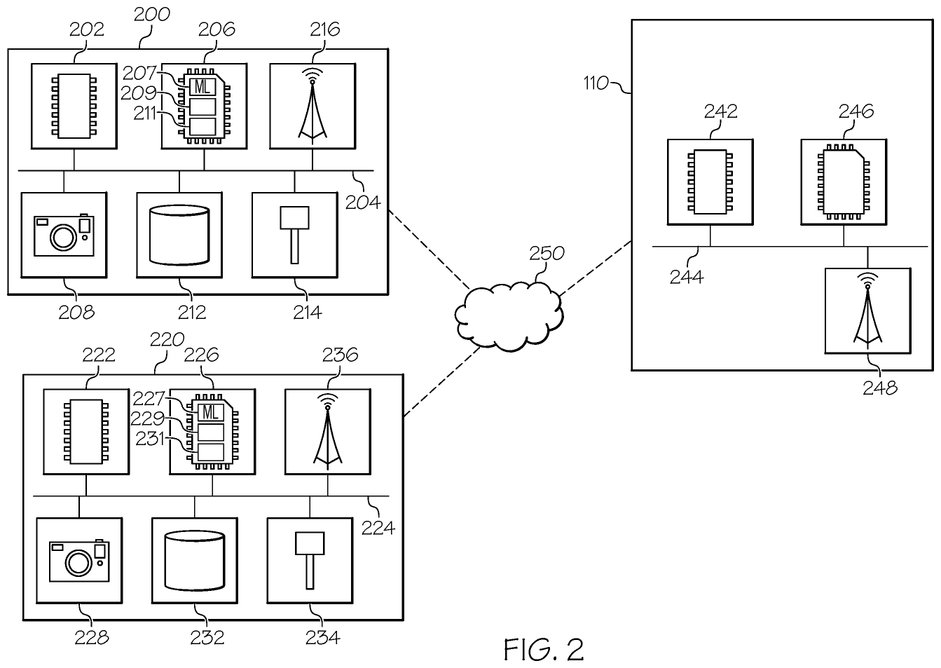

FIG. 2 depicts a schematic diagram of a system for selecting a vehicle between a pair of vehicles for decentralized machine learning, according to one or more embodiments shown and described herein. The system includes a first vehicle system 200 and a second vehicle system 220. In some embodiments, the system may also include an edge server 110. While FIG. 2 depicts two vehicle systems, more than two vehicle systems may communicate with the edge server 110.

It is noted that, while the first vehicle system 200 and the second vehicle system 220 are depicted in isolation, each of the first vehicle system 200 and the second vehicle system 220 may be included within a vehicle in some embodiments, for example, respectively within any two of the vehicles 102, 104, 106, 108 of FIG. 1. In embodiments in which each of the first vehicle system 200 and the second vehicle system 220 is included within an edge node, the edge node may be an automobile or any other passenger or non-passenger vehicle such as, for example, a terrestrial, aquatic, and/or airborne vehicle. In some embodiments, the vehicle is an autonomous vehicle that navigates its environment with limited human input or without human input.

The first vehicle system 200 includes one or more processors 202. Each of the one or more processors 202 may be any device capable of executing machine readable and executable instructions. Accordingly, each of the one or more processors 202 may be a controller, an integrated circuit, a microchip, a computer, or any other computing device. The one or more processors 202 are coupled to a communication path 204 that provides signal interconnectivity between various modules of the system. Accordingly, the communication path 204 may communicatively couple any number of processors 202 with one another, and allow the modules coupled to the communication path 204 to operate in a distributed computing environment. Specifically, each of the modules may operate as a node that may send and/or receive data. As used herein, the term “communicatively coupled” means that coupled components are capable of exchanging data signals with one another such as, for example, electrical signals via conductive medium, electromagnetic signals via air, optical signals via optical waveguides, and the like.

Accordingly, the communication path 204 may be formed from any medium that is capable of transmitting a signal such as, for example, conductive wires, conductive traces, optical waveguides, or the like. In some embodiments, the communication path 204 may facilitate the transmission of wireless signals, such as WiFi, Bluetooth®, Near Field Communication (NFC), and the like. Moreover, the communication path 204 may be formed from a combination of mediums capable of transmitting signals. In one embodiment, the communication path 204 comprises a combination of conductive traces, conductive wires, connectors, and buses that cooperate to permit the transmission of electrical data signals to components such as processors, memories, sensors, input devices, output devices, and communication devices. Accordingly, the communication path 204 may comprise a vehicle bus, such as for example a LIN bus, a CAN bus, a VAN bus, and the like. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium.

The first vehicle system 200 includes one or more memory modules 206 coupled to the communication path 204. The one or more memory modules 206 may comprise RAM, ROM, flash memories, hard drives, or any device capable of storing machine readable and executable instructions such that the machine readable and executable instructions can be accessed by the one or more processors 202. The machine readable and executable instructions may comprise logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine readable and executable instructions and stored on the one or more memory modules 206. Alternatively, the machine readable and executable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components. The one or more processor 202 along with the one or more memory modules 206 may operate as a controller for the first vehicle system 200.

The one or more memory modules 206 includes a machine learning (ML) model 207, an edge encounter score calculation module 209, and an ML aggregating module 211. Each of the ML model 207, the edge encounter score calculation module 209, and the ML aggregating module 211 may include, but not limited to, routines, subroutines, programs, objects, components, data structures, and the like for performing specific tasks or executing specific data types as will be described below.

The ML model 207 may by a machine learning model including, but not limited to, supervised learning models such as neural networks, decision trees, linear regression, and support vector machines, unsupervised learning models such as Hidden Markov models, k-means, hierarchical clustering, and Gaussian mixture models, and reinforcement learning models such as temporal difference, deep adversarial networks, and Q-learning.

The edge encounter score calculation module 209 calculates an edge encounter score for the vehicle based on a movement momentum of the vehicle and a direction from a location of the vehicle to one or more edge servers.

The ML aggregating module 211 collects and aggregates machine learning models of a pair of vehicles (e.g., vehicles 102 and 104) to output an aggregated machine learning model to be updated to an edge server.

Referring still to FIG. 2, the first vehicle system 200 comprises one or more sensors 208. The one or more sensors 208 may include a forward facing camera installed in a vehicle. The one or more sensors 208 may be any device having an array of sensing devices capable of detecting radiation in an ultraviolet wavelength band, a visible light wavelength band, or an infrared wavelength band. The one or more sensors 208 may have any resolution. In some embodiments, one or more optical components, such as a mirror, fish-eye lens, or any other type of lens may be optically coupled to the one or more sensors 208. In embodiments described herein, the one or more sensors 208 may provide image data to the one or more processors 202 or another component communicatively coupled to the communication path 204. In some embodiments, the one or more sensors 208 may also provide navigation support. That is, data captured by the one or more sensors 208 may be used to autonomously or semi-autonomously navigate a vehicle. The first vehicle system 200 may detect external objects such as other vehicles using the one or more sensors 208.

In some embodiments, the one or more sensors 208 include one or more imaging sensors configured to operate in the visual and/or infrared spectrum to sense visual and/or infrared light. Additionally, while the particular embodiments described herein are described with respect to hardware for sensing light in the visual and/or infrared spectrum, it is to be understood that other types of sensors are contemplated. For example, the systems described herein could include one or more LIDAR sensors, radar sensors, sonar sensors, or other types of sensors for gathering data that could be integrated into or supplement the data collection described herein. Ranging sensors like radar sensors may be used to obtain a rough depth and speed information for the view of the first vehicle system 200.

The first vehicle system 200 comprises a satellite antenna 214 coupled to the communication path 204 such that the communication path 204 communicatively couples the satellite antenna 214 to other modules of the first vehicle system 200. The satellite antenna 214 is configured to receive signals from global positioning system satellites. Specifically, in one embodiment, the satellite antenna 214 includes one or more conductive elements that interact with electromagnetic signals transmitted by global positioning system satellites. The received signal is transformed into a data signal indicative of the location (e.g., latitude and longitude) of the satellite antenna 214 or an object positioned near the satellite antenna 214, by the one or more processors 202.

The first vehicle system 200 comprises one or more vehicle sensors 212. Each of the one or more vehicle sensors 212 is coupled to the communication path 204 and communicatively coupled to the one or more processors 202. The one or more vehicle sensors 212 may include one or more motion sensors for detecting and measuring motion and changes in motion of a vehicle, e.g., the vehicle 101. The motion sensors may include inertial measurement units. Each of the one or more motion sensors may include one or more accelerometers and one or more gyroscopes. Each of the one or more motion sensors transforms sensed physical movement of the vehicle into a signal indicative of an orientation, a rotation, a velocity, or an acceleration of the vehicle.

Still referring to FIG. 2, the first vehicle system 200 comprises network interface hardware 216 for communicatively coupling the first vehicle system 200 to the second vehicle system 220 and/or the edge server 110. The network interface hardware 216 can be communicatively coupled to the communication path 204 and can be any device capable of transmitting and/or receiving data via a network. Accordingly, the network interface hardware 216 can include a communication transceiver for sending and/or receiving any wired or wireless communication. For example, the network interface hardware 216 may include an antenna, a modem, LAN port, WiFi card, WiMAX card, mobile communications hardware, near-field communication hardware, satellite communication hardware and/or any wired or wireless hardware for communicating with other networks and/or devices. In one embodiment, the network interface hardware 216 includes hardware configured to operate in accordance with the Bluetooth® wireless communication protocol. The network interface hardware 216 of the first vehicle system 200 may transmit its data to the second vehicle system 220 or the edge server 110. For example, the network interface hardware 216 of the first vehicle system 200 may transmit vehicle data, location data, updated local model data and the like to the edge server 110.

The first vehicle system 200 may connect with one or more external vehicle systems (e.g., the second vehicle system 220) and/or external processing devices (e.g., the edge server 110) via a direct connection. The direct connection may be a vehicle-to-vehicle connection (“V2V connection”), a vehicle-to-everything connection (“V2X connection”), or a mmWave connection. The V2V or V2X connection or mmWave connection may be established using any suitable wireless communication protocols discussed above. A connection between vehicles may utilize sessions that are time-based and/or location-based. In embodiments, a connection between vehicles or between a vehicle and an infrastructure element may utilize one or more networks to connect, which may be in lieu of, or in addition to, a direct connection (such as V2V, V2X, mmWave) between the vehicles or between a vehicle and an infrastructure. By way of non-limiting example, vehicles may function as infrastructure nodes to form a mesh network and connect dynamically on an ad-hoc basis. In this way, vehicles may enter and/or leave the network at will, such that the mesh network may self-organize and self-modify over time. Other non-limiting network examples include vehicles forming peer-to-peer networks with other vehicles or utilizing centralized networks that rely upon certain vehicles and/or infrastructure elements. Still other examples include networks using centralized servers and other central computing devices to store and/or relay information between vehicles.

Still referring to FIG. 2, the first vehicle system 200 may be communicatively coupled to the edge server 110 by the network 250. In one embodiment, the network 250 may include one or more computer networks (e.g., a personal area network, a local area network, or a wide area network), cellular networks, satellite networks and/or a global positioning system and combinations thereof. Accordingly, the first vehicle system 200 can be communicatively coupled to the network 250 via a wide area network, via a local area network, via a personal area network, via a cellular network, via a satellite network, etc. Suitable local area networks may include wired Ethernet and/or wireless technologies such as, for example, Wi-Fi. Suitable personal area networks may include wireless technologies such as, for example, IrDA, Bluetooth®, Wireless USB, Z-Wave, ZigBee, and/or other near field communication protocols. Suitable cellular networks include, but are not limited to, technologies such as LTE, WiMAX, UMTS, CDMA, and GSM.

Still referring to FIG. 2, the second vehicle system 220 includes one or more processors 222, one or more memory modules 226, one or more sensors 228, one or more vehicle sensors 232, a satellite antenna 234, and a communication path 224 communicatively connected to the other components of the second vehicle system 220. The components of the second vehicle system 220 may be structurally similar to and have similar functions as the corresponding components of the first vehicle system 200 (e.g., the one or more processors 222 corresponds to the one or more processors 202, the one or more memory modules 226 corresponds to the one or more memory modules 206, the one or more sensors 228 corresponds to the one or more sensors 208, the one or more vehicle sensors 232 corresponds to the one or more vehicle sensors 212, the satellite antenna 234 corresponds to the satellite antenna 214, the communication path 224 corresponds to the communication path 204, the network interface hardware 236 corresponds to the network interface hardware 216, the ML model 227 corresponds to the ML model 207, an edge encounter score calculation module 229 corresponds to the edge encounter score calculation module 209, and a ML aggregating module 231 corresponds to the ML aggregating module 211).

Still referring to FIG. 2, the edge server 110 includes one or more processors 242, one or more memory modules 246, network interface hardware 248, and a communication path 244. The one or more processors 242 may be a controller, an integrated circuit, a microchip, a computer, or any other computing device. The one or more memory modules 246 may comprise RAM, ROM, flash memories, hard drives, or any device capable of storing machine readable and executable instructions such that the machine readable and executable instructions can be accessed by the one or more processors 242.

FIG. 3 depicts a flowchart for selecting a vehicle between a pair of vehicles for decentralized machine learning, according to one or more embodiments shown and described herein.

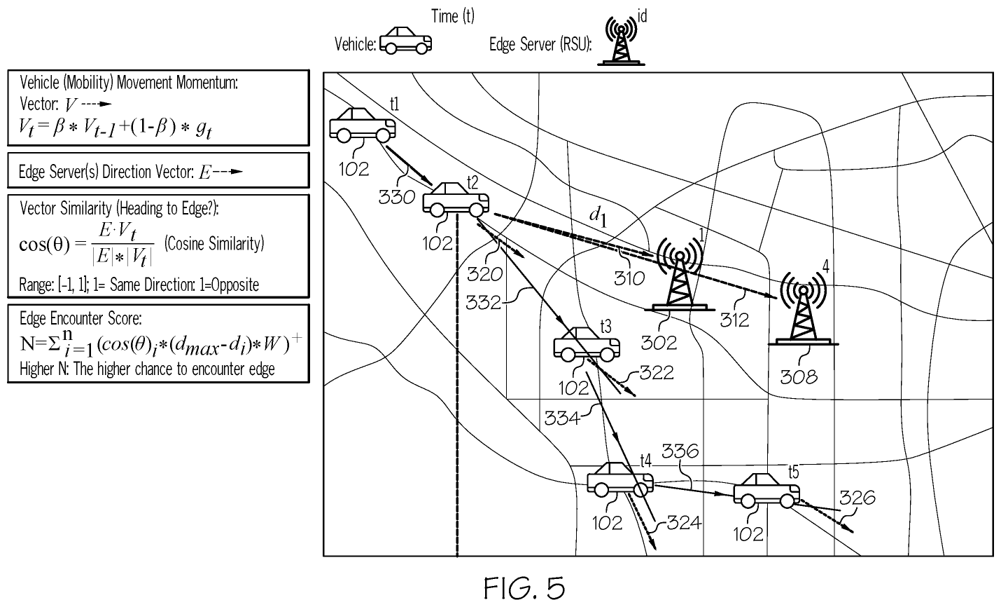

In step 340, a vehicle obtains an edge encounter score for each of a pair of vehicles calculated based on a movement momentum of each of the pair of vehicles and a direction from a location of each of the pair of vehicles to each of one or more edge servers. By referring to FIGS. 1A, 1B, 3, 4, and 5, the vehicle 102 calculates an edge encounter score for the vehicle 102 based on the movement momentum of the vehicle 102 and a direction from the location of the vehicle 102 to each of one or more edge servers (e.g., edge servers 302 and 308 in FIG. 5). Similarly, the vehicle 104 calculates an edge encounter score for the vehicle 104 based on a movement momentum of the vehicle 104 and a direction from a location of the vehicle 104 to each of one or more edge servers. The edge encounter score is represented in the following equation.

$$N = {\sum }_{i = 1}^{n} {( {( \frac{E \cdot {V}_{t}}{\vert E \vert * \vert {V}_{t} \vert} )}_{i} * ( {d}_{max} - {d}_{i} ) * W )}^{+} \qquad Equation 1$$

The parameter E is the direction of an edge server relative to the vehicle's current location. The parameter i denotes the ith edge server within the communication range of a given vehicle, e.g., the vehicle 102 in FIG. 5. dₘₐₓ is the maximum communication range of the vehicle 102. W is an edge weight, which is determined based on the current utilization rate of the edge server. For example, the value of W is inversely correlated to the current utilization rate of the edge server. By referring to FIG. 4, the status of the edge server 302 is busy and the status of the edge server 304 is idle. Because the edge server 304 has more resources to be utilized than the edge server 302, the value W of the edge server 304 is 200, which is higher than the value W of the edge server 302, which is 100. If an edge server is not available for computing, then the value of W may be 0. For example, in FIG. 4, the edge server 306 is not available for computing, and the value of W of the edge server 306 is 0.

Vₜ denotes the movement momentum for the vehicle 102. dᵢ is the distance from the vehicle to the ith edge server. The movement momentum as used in this disclosure does not carry the traditional physics-based definition. Instead, the movement momentum of the present disclosure aligns more closely with the concept of momentum utilized in machine learning optimization methods. The calculation for the movement momentum Vₜ is defined in the equation 2 below.

$${V}_{t} = β * {V}_{t - 1} + ( 1 - β ) * {g}_{t} \qquad Equation 2$$

Vₜ₋₁ represents the momentum from the previous time slot. The parameter β control the influence of the current internal motion gₜ and the movement momentum from the previous time slot (Vₜ₋₁) on the newly momentum (Vₜ). For example, when β is zero, only the present motion (gₜ) is taken into account, disregarding the past momentum (Vₜ₋₁). By referring to FIG. 5, if the current time is t₃, the movement momentum at t₃, V₃ 322, is calculated based on V₂ 320 and g₃ 334. Similarly, if the current time is t₂, the movement momentum at t₂, V₂ 320, is calculated based on V₁ (not shown in FIG. 5) and g₂ 332.

By leveraging both E and Vₜ, the present disclosure calculates the detection similarity between the edge server (E) and the vehicle's current momentum (Vₜ). This calculation utilizes the cosine similarity method, as shown in the equation 3 below.

$$cos ( θ ) = \frac{E \cdot {V}_{t}}{\vert E \vert * \vert {V}_{t} \vert} \qquad Equation 3$$

The outcome of the cosine similarity calculation ranges from −1 to 1. The outcome value of 1 indicates that the vehicle's movement momentum aligns exactly with the direction of the edge server. Conversely, the outcome value of −1 indicates the exact opposite direction. The outcome value of 0 denotes a right angle formation between the two vectors. In calculating the edge encounter score, the present disclosure only factors in edge servers that yield a positive cosine similarity value. This is because edge servers located in the opposite direction of the vehicle's momentum are not considered as candidates for uploading machine learning models.

Once each of the pair of vehicles calculates its edge encounter score, each shares the edge encounter score with the other vehicle. For example, by referring to FIG. 1B, the vehicle 102 calculates its edge encounter score as 7 and transmits the edge encounter score to the vehicle 104. Similarly, the vehicle 104 calculates its edge encounter score as 1 and transmits the edge encounter score to the vehicle 102.

Referring back to FIG. 3, in step 342, the vehicle selects one of the pair of vehicles having a higher edge encounter score than other vehicle. For example, by referring to FIG. 1B, the controller of the vehicle 102 selects the vehicle 102 as a representer because the vehicle 102 has the edge encounter number of 7 which is greater than the edge encounter number of 1 of the vehicle 104. Then, the vehicle 102 may communicate the selection to the vehicle 104 such that the vehicle 104 transmits its machine learning model to the vehicle 102.

Referring back to FIG. 3, in step 344, the selected vehicle aggregates the machine learning model of the selected vehicle and the machine learning model of the other vehicle of the pair of vehicles. For example, by referring to FIG. 1B, the controller of the vehicle 102 aggregates the machine learning model of the vehicle 102 and the machine learning model of the vehicle 104. The machine learning model of the vehicle 102 has been locally trained by the vehicle 102 using data obtained by the sensors of the vehicle 102, and the machine learning model of the vehicle 104 has been locally trained by the vehicle 104 using data obtained by the sensors of the vehicle 102.

Referring back to FIG. 3, in step 346, the selected vehicle uploads the aggregated machine learning model to one of the one or more edge servers. For example, by referring to FIG. 1B, the vehicle 102 uploads the aggregated machine learning model to the edge server 110 when the vehicle 102 within a communication range of the edge server 110. In some embodiments, the vehicle 102 may transmit the aggregated machine learning model to the vehicle 104.

In step 348, the selected vehicle operates based on the aggregated machine learning model. For example, by referring to FIG. 1B, the vehicle 102 autonomously drives using the aggregated machine learning model. In some embodiments, the vehicle 102 may receive a global machine learning model from the edge server 110 after uploading the aggregated machine learning model to the edge server 110. The edge server 110 may receive aggregated machine learning models from a plurality of representers, obtain the global machine learning model based on the received aggregated machine learning models, and transmit the global machine learning model to the vehicle 102. The vehicle 102 may autonomously drive using the global machine learning model.

FIG. 4 illustrates an exemplary scenario where a vehicle calculates an edge encounter score, according to one or more embodiments shown and described herein.

FIG. 4 illustrates the vehicle 102 at time t₁ and time t₂. At time t₂, the vehicle 102 may be within a communication range of each of edge servers 302, 304, 306. The status of the edge server 302 is busy, the status of the edge server 304 is idle, and the edge server 306 is not available for processing a machine leaning model. Then, the vehicle 102 calculates an edge encounter score with respect to the edge servers 302 and 304 using the equation 1 above. At time t₂, another vehicle, e.g., the vehicle 104 (not shown in FIG. 4) may be within a communication range of the vehicle 102, and calculate an edge encounter score with respect to the edge servers 302 and 304. Between the vehicle 102 and the vehicle 104, the vehicle who has a higher edge encounter score becomes a representer and aggregates the machine learning models of the vehicles 102 and 104.

FIG. 5 illustrates another exemplary scenario where a vehicle calculates an edge encounter score, according to another embodiments shown and described herein. FIG. 5 illustrates the vehicle 102 at different locations at different times t₁, t₂, t₃, t₄, t₅. At time t₂, two edge servers 302 and 308 are within a communication range of the vehicle 102. At time t₂, the movement momentum 320 of the vehicle 102 is Vₜ₂ and the present motion 332 is gₜ₂. There are two edge server direction vectors: E₁ and E₄. E₁ is a vector with respect to the edge server 302 and E₄ is a vector with respect to the edge server 308. Then, the vehicle 102 calculates the edge encounter score using Equation 1 above if the vehicle 102 encounters with another vehicle at time t₂.

If the vehicle 102 encounters another vehicle at time t₃, the vehicle 102 may calculate the edge encounter score at time t₃ using Equation 1. At time t₃, the movement momentum 322 of the vehicle 102 is Vₜ₃ and the present motion 334 is gₜ₃. There may be still two edge servers 302 and 308 available at time t₃, and the vehicle 102 may obtain edge server direction vectors for the edge servers 302 and 308. In a similar manner, the vehicle 102 may calculate an edge encounter score at time t₄ or t₅ if the vehicle 102 encounters with another vehicle at time t₄ or t₅.

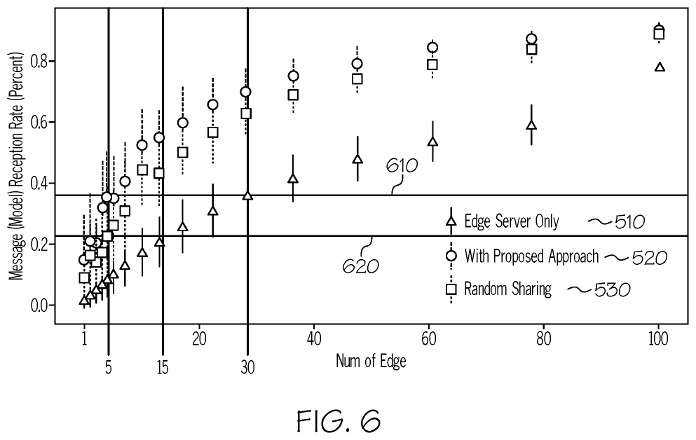

FIG. 6 depicts simulation result of message receptions rates, according to one or more embodiments shown and described herein. In FIG. 6, the X-axis represents the number of edge servers deployed in a simulated area, while the Y-axis indicates the percentage of messages or models received by these edge servers. Each dot in the results signifies the average message reception rate for a given number of edge servers, and the connecting line shows the standard deviation of these results.

The triangle results 510 were obtained with only edge servers without using edge encounter scores, while the circle results 520 were obtained using the approach of present disclosure that utilizes edge encounter scores. The square results 530 were obtained using random sharing. As evident from the results, when compared to the performance with each number of edge servers, the circle results 520 of the present disclosure notably enhances the message or model reception rate more than doubling when the number of edge servers is relatively small.

Furthermore, when compared to square results 530, the random sharing approach where vehicles exchange messages without an edge encounter score based selection upon encountering each other and sending them to an edge server once they encounter one, the methodology of the present disclosure consistently outperforms.

When analyzing the results horizontally, the random sharing approach may match the performance of 15 edge servers by utilizing just 5 edge servers as depicted by the horizontal line 610. However, compared to the random sharing approach, the approach of the present disclosure can achieve the performance equivalent to 30 edge servers with merely 5 edge servers as illustrated by the horizontal line 620. This demonstration indicates that the methodology of the present disclosure enables at least an 83.33% reduction in edge server infrastructure. The methodology of the present disclosure provides a saving that is double when compared to the random sharing approach.

It should be understood that embodiments described herein are directed to a method for updating a machine learning model for vehicles. The method includes obtaining an edge encounter score for each of a pair of vehicles calculated based on a movement momentum of each of the pair of vehicles and a direction from a location of each of the pair of vehicles to each of one or more edge servers, selecting one of the pair of vehicles having a higher edge encounter score than other vehicle, aggregating a machine learning model of the selected vehicle and a machine learning model of the other vehicle of the pair of vehicles, uploading the aggregated machine learning model to one of the one or more edge servers, and operating the selected vehicle based on the aggregated machine learning model.

The present disclosure provides several advantages over conventional systems. The present disclosure provides a highly efficient method for determining the future trajectory of a vehicle without requiring any interaction with the driver. In addition, the present disclosure accurately calculates the chance for a vehicle to encounter edge server. Further, the present disclosure uses a decentralized learning method to enhance federated learning. This approach substantially increases the coverage area, reduces communication and computational requirements for edge servers, and decreases the infrastructural cost of the edge servers.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method for updating a machine learning model for vehicles, the method comprising:
obtaining an edge encounter score for each of a pair of vehicles calculated based on a movement momentum of each of the pair of vehicles and a direction from a location of each of the pair of vehicles to each of one or more edge servers;
selecting one of the pair of vehicles having a higher edge encounter score than other vehicle;
aggregating a machine learning model of the selected vehicle and a machine learning model of the other vehicle of the pair of vehicles;
uploading the aggregated machine learning model to one of the one or more edge servers; and
operating the selected vehicle based on the aggregated machine learning model.

2. The method of claim 1, wherein the edge encounter score for each of a pair of vehicles is calculated further based on a distance from the location of each of the pair of vehicles to each of the one or more edge servers.

3. The method of claim 1, wherein the edge encounter score for each of a pair of vehicles is calculated further based on utilization status of each of the one or more edge servers.

4. The method of claim 1, wherein the movement momentum of each of the pair of vehicles is calculated based on a weighted sum of a previous movement momentum and a current motion of corresponding vehicle.

5. The method of claim 1, further comprising:
identifying that each of the one or more edge servers is within a predetermined distance of one of the pair of vehicles.

6. The method of claim 1, further comprising:
transmitting, by the selected vehicle, the aggregated machine learning model to the other vehicle.

7. The method of claim 1, wherein each of the pair of vehicles calculates corresponding edge encounter score and transmits corresponding edge encounter sore to the other vehicle.

8. The method of claim 1, wherein each of the pair of vehicles is an autonomous driving vehicle.

9. A system for updating a machine learning model for vehicles, the system comprising:
a first vehicle comprising a first machine learning model and a processor; and
a second vehicle comprising a second machine learning model,
wherein the processor is programmed to:
obtain an edge encounter score for each of the first and second vehicles calculated based on a movement momentum of each of the first and second vehicles and a direction from a location of each of the first and second vehicles to each of one or more edge servers;
determine that the first vehicle has a higher edge encounter score than the second vehicle;
aggregate the first machine learning model and the second machine learning model;
upload the aggregated machine learning model to one of the one or more edge servers; and
operate the first vehicle based on the aggregated machine learning model.

10. The system of claim 9, wherein the edge encounter score for each of the first and second vehicles is calculated further based on a distance from the location of each of the first and second vehicles to each of the one or more edge servers.

11. The system of claim 9, wherein the edge encounter score for each of the first and second vehicles is calculated further based on utilization status of each of the one or more edge servers.

12. The system of claim 9, wherein the movement momentum of each of the first and second vehicles is calculated based on a weighted sum of a previous movement momentum and a current motion of corresponding vehicle.

13. The system of claim 9, where the processor is further programmed to:
identify that each of the one or more edge servers is within a predetermined distance of one of the first and second vehicles.

14. The system of claim 9, where the processor is further programmed to:
transmit the aggregated machine learning model to the second vehicle.

15. The system of claim 9, wherein each of the first and second vehicles calculates corresponding edge encounter score and transmits corresponding edge encounter sore to other vehicle.

16. The system of claim 9, wherein each of the first and second vehicles is an autonomous driving vehicle.

17. A non-transitory computer readable medium storing instructions, when executed by a processor, causing the processor to:
obtain an edge encounter score for each of a pair of vehicles calculated based on a movement momentum of each of the pair of vehicles and a direction from a location of each of the pair of vehicles to each of one or more edge servers;
select one of the pair of vehicles having a higher edge encounter score than other vehicle;
aggregate a machine learning model of the selected vehicle and a machine learning model of the other vehicle of the pair of vehicles;
upload the aggregated machine learning model to one of the one or more edge servers; and
operate the selected vehicle based on the aggregated machine learning model.

18. The non-transitory computer readable medium of claim 17, wherein the edge encounter score for each of a pair of vehicles is calculated further based on a distance from the location of each of the pair of vehicles to each of the one or more edge servers.

19. The non-transitory computer readable medium of claim 17, wherein the edge encounter score for each of a pair of vehicles is calculated further based on utilization status of each of the one or more edge servers.

20. The non-transitory computer readable medium of claim 17, wherein the movement momentum of each of the pair of vehicles is calculated based on a weighted sum of a previous movement momentum and a current motion of corresponding vehicle.
